(19) United States
(12) Patent Application Publication
(10) Pub. No.: US 2026/0028430 A1
(43) Pub. Date: Jan. 29, 2026

(54) DATE POMACE-DERIVED CELLULOSE NANOFIBRILS

(71) Applicant: Khalifa University of Science and Technology, Abu Dhabi (AE)

(72) Inventors: Fawzi BANAT, Abu Dhabi (AE); Vengatesan Muthukumaraswamy RANGARAJ, Abu Dhabi (AE); Blaise Leopold TARDY, Abu Dhabi (AE); Raghad ABDELRAHMAN, Abu Dhabi (AE); Mohamed Hamid SALIM, Abu Dhabi (AE); Mohamed Mohsin ALHAMMADI, Abu Dhabi (AE); Malak Mohammed ABU ZAID, Abu Dhabi (AE)

(21) Appl. No.: 19/262,922

(22) Filed: Jul. 8, 2025

Related U.S. Application Data
(60) Provisional application No. 63/676,109, filed on Jul. 26, 2024.

(51) Int. Cl. C08B 1/08

(52) U.S. Cl. CPC C08B 1/08

(57) ABSTRACT

A method for preparing cellulose nanofibrils comprising providing date fruit pomace, heating water to at least 70° C., contacting the date fruit pomace with water either before or after heating to produce hot water-treated date fruit pomace, and processing the hot water-treated date fruit pomace to produce cellulose nanofibrils. Incorporation of a widely-produced byproduct such as date fruit pomace in the production of useful cellulose nanofibrils promotes sustainability and waste reduction. Further, date fruit pomace is an exceptional cellulosic material, being rich in cellulose and having weakly connected fibers which allow efficient fibrillation into CNFs using only moderately-hot water and low-energy mechanical processing.

### TECHNICAL FIELD

The subject matter disclosed herein relates to methods for producing cellulose nanofibrils from date fruit pomace.

### BACKGROUND

In recent years, scientific research has focused on determining the viability of utilizing natural biomaterials to reduce reliance on finite energy reservoirs and mitigate the negative impacts on ecology and public health caused by the durability and non-degradability of fossil fuel derivatives. Among the most promising natural biomaterials suitable for these purposes are biopolymers derived from various abundant biomass reservoirs. Cellulose, the most common natural polymer globally, comprises D-glucose units, which provide enormous potential for developing a wide range of biomaterials. Primary sources of cellulose span agricultural and food industrial realms, encompassing wood and non-wood origins. Certain cellulosic materials are lignocellulosic materials which may contain cellulose, hemicellulose, and lignin.

Among the various biomaterials derived from cellulose, nanocellulose (NC) distinguishes itself as the foremost naturally occurring advanced nanomaterial, endowed with a plethora of advantages such as nano-scale dimensions, high surface area, renewability, high aspect ratio, distinct shape, the highest strength among synthetic and natural polymers, and good optical properties. NC encompasses three primary types: cellulose nanocrystals (CNCs), cellulose nanofibrils (CNFs), and bacterial nanocellulose (BNC), each discernible through their unique chemical compositions and diverse physical attributes, including particle sizes, morphologies, and crystallinities. CNCs are characterized by having pristine crystalline structures, whereas CNFs exhibit a blend of crystalline and amorphous regions that can be precisely engineered into an interconnected matrix. The versatile applications of NCs span various domains, encompassing biomedical science, the paper and pulp industries, mechanically reinforced polymer composites, antibacterial coatings, and environmental remediation endeavors. Compared to CNCs, CNFs exhibit a longer length, higher aspect ratio (length-to-diameter), larger surface area, and greater concentration of hydroxyl groups, rendering them more readily amendable to surface modifications. Comprising alternating crystalline and amorphous regions of cellulose, CNFs represent pure cellulose.

The composition of CNFs exhibits notable variation associated with extraction technique and natural source, with their properties being significantly influenced by extraction and isolation techniques. Factors such as the composition of the source biomass, hemicellulose, and lignin contents, cellulose content after post-purification, and pre- and post-treatment methodologies play pivotal roles in shaping the characteristics of CNFs, encompassing aspects like shape, architecture, structure, and size.

Some techniques are utilized to remove lignin and/or hemicellulose from the cellulosic materials to change the characteristics of the resulting CNFs. Among these techniques is autohydrolysis, wherein hot water (typically at or above 140° C.) degrades hemicellulose into soluble sugars or oligomers, allowing them to be solubilized and removed from the cellulosic material.

Methods of producing CNFs have been developed, typically involving energy-intensive mechanical processes, reagent-intensive processes, or surface-modifying oxidation processes. CNFs may be produced by subjecting cellulosic materials to mechanical disruption techniques such as homogenization, micro-fluidization, grinding, cryo-crushing, and high-intensity ultrasonication. However, these mechanical processes demand substantial energy input, necessitating preliminary pre-treatment methods to mitigate energy requirements.

However, these mechanical processes demand substantial energy input, necessitating preliminary pre-treatment methods to mitigate energy requirements. Some pre-treatment methods include rigorous oxidation techniques to change surface chemistry. These techniques may involve combinations of highly concentrated sulfuric acid, zinc chloride, periodate, or 2,2,6,6-Tetramethylpiperidine-1-oxyl (“TEMPO”). These mechanical and chemical processes currently stand as the principal methodologies for CNF production, but are nonetheless burdened by their high cost, environmental ramifications, and incorporation of hazardous chemicals.

### SUMMARY

According to one aspect, a method for preparing cellulose nanofibrils comprising providing date pomace, heating water to at least 70° C., contacting the date fruit pomace with the water either concurrent with or after heating water to produce hot water-treated date fruit pomace, and processing the hot water-treated date fruit pomace to produce cellulose nanofibers.

According to another aspect, a method for preparing cellulose nanofibrils comprising providing date fruit pomace, heating water to at least 70° C., contacting the date fruit pomace with water either before or after heating, contacting the hot water-treated date fruit pomace with one or more alkalis, contacting the hot water-treated date fruit pomace with one or more oxidizing agents, and processing the hot water-treated date fruit pomace to produce cellulose nanofibrils, wherein contacting with one or more alkalis can be performed at any time prior to processing and contacting with one or more oxidizing agents can be performed at any time prior to processing.

According to another aspect, a method for preparing cellulose nanofibrils comprising providing date fruit pomace, heating water to between 70-100° C., contacting the date fruit pomace with water either before or after heating to produce hot water-treated date fruit pomace, and processing the hot water-treated date fruit pomace to produce cellulose nanofibrils.

### BRIEF DESCRIPTION OF THE DRAWINGS

This written disclosure describes illustrative embodiments that are non-limiting and non-exhaustive. Reference is made to illustrative embodiments that are depicted in the figures, in which:

FIG. 1 illustrates a flowchart showing method 100 for preparing cellulose nanofibrils, according to some embodiments.

FIG. 2A illustrates an FE-SEM image of cellulose nanofibril hydrocolloids made with water treated date fruit pomace (WTP-CNF), according to some embodiments.

FIG. 2B illustrates an FE-SEM image of WTP-CNF, according to some embodiments.

FIG. 2C illustrates an FE-SEM image of cellulose nanofibril hydrocolloids made with alkali treated date fruit pomace (ATP-CNF), according to some embodiments.

FIG. 2D illustrates an FE-SEM image of ATP-CNF, according to some embodiments.

FIG. 2E illustrates an FE-SEM image of cellulose nanofibril hydrocolloids made with oxidizing bleach treated date fruit pomace (BTP-CNF), according to some embodiments.

FIG. 2F illustrates an FE-SEM image of BTP-CNF, according to some embodiments.

FIG. 3A illustrates a graph showing the distribution of nanofibril diameters of WTP-CNF as measured in FE-SEM images.

FIG. 3B illustrates a graph showing the distribution of nanofibril diameters of ATP-CNF as measured in FE-SEM images.

FIG. 3C illustrates a graph showing the distribution of nanofibril diameters of BTP-CNF as measured in FE-SEM images.

FIG. 4 illustrates x-ray diffraction patterns of ATP-CNF and BTP-CNF.

FIG. 5A illustrates a graph showing the results of frequency sweep measurements conducted on hydrocolloids made using BTP-CNF, expressed as storage modulus (G′) and loss modulus (G″) as functions of angular frequency.

FIG. 5B illustrates a graph showing complex viscosity (η*) of hydrocolloids made using BTP-CNF, expressed as a function of angular frequency.

FIG. 6 illustrates a graph showing results of Alamar Blue assays conducted on cells treated with hydrocolloids made using BTP-CNF and untreated (control) cells.

### DETAILED DESCRIPTION

The present disclosure provides methods for preparing cellulose nanofibrils (CNFs) using date fruit pomace. CNFs produced this way find utility in diverse applications including food packaging. Further, the methods disclosed herein avoid use of harsh chemicals, high-temperature hot water treatment, or energy-intensive mechanical treatments. Date fruit pomace is often discarded as a waste byproduct from various forms of date fruit (also called “date palm fruit”) processing and consumption, leading to their widespread availability, especially in arid regions with high date palm fruit production. Incorporation of a widely-produced byproduct in the production of useful cellulose nanofibrils promotes sustainability and waste reduction. Date fruit pomace is an exceptional cellulosic material, being rich in cellulose and having weakly connected fibers which allow efficient fibrillation into CNFs using only moderately-hot water and low-energy mechanical processing. Additional techniques such as alkali or oxidizing agent treatments may be used to remove impurities such as hemicellulose and lignin and further alter characteristics of resulting CNFs.

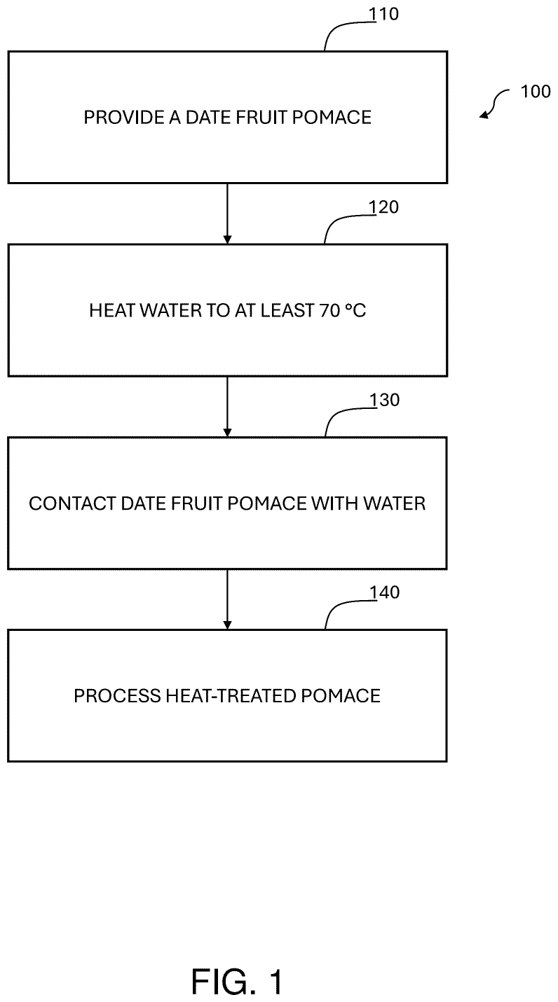

FIG. 1 illustrates a flowchart showing method 100 for preparing cellulose nanofibrils, according to some embodiments. Method 100 includes the following steps: providing 110 date fruit pomace, heating 120 water to at least 70° C., contacting 130 the date fruit pomace with water either concurrent or after heating water to produce hot water-treated date fruit pomace, and processing 140 the hot water-treated date fruit pomace to produce cellulose nanofibrils.

Providing 110 includes providing date fruit pomace. Dates are fruits from the plant Phoenix dactylifera, also called “date palm.” Date fruit pomace is a pulpy residual byproduct of date fruit syrup extraction, often regarded as a waste material. Date fruit pomace contains substantial quantities of sugars (including glucose, fructose, and sucrose), soluble fibers (such as pectin), lignin, cellulose, and hemicellulose. In addition to date fruit pomace being rich in cellulose, its cellulose fibers are generally weakly connected, allowing efficient fibrillation into CNFs. As a result, date fruit pomace is an excellent source for cellulose nanofibrils. In some embodiments, date fruit pomace is made from one or more varieties of dates. The following is a non-exhaustive list of several common date varieties suitable for use in this method: Medjool, Deglet Noor, Ajwa, Honey, Piarom, Mazafati, Barhi, Rabbi, Sayer, Dayri, Halawi, Sukkary, Khudri, Zahidi, Safawi, Kimia, Omani, Khalas, Farth, Khunaizi, Thoory, and Mabroom.

Heating 120 includes heating water to at least 70° C. In some embodiments, heated water is used to pretreat the date fruit pomace prior to mechanically processing. In some embodiments, water may include one or more of de-ionized water, distilled water, demineralized water, or tap water. De-ionized, distilled, or demineralized water lack or have fewer impurities that may interfere with the fibrillation process. In some embodiments, water temperature is at least, equal to, or between any two of 70, 75, 80, 85, 90, 95, and 100° C.

Contacting 130 includes contacting date fruit pomace with water to produce hot water-treated date fruit pomace. Contacting with water is an effective technique to prepare date fruit pomace prior to fibrillation during processing 140. In some embodiments, contacting 130 with water removes water-soluble impurities inside the date fruit pomace such as soluble sugars (glucose, fructose, and sucrose), and fibers (pectin). In some embodiments, contacting 130 with water softens or loosens the cellulosic matrix of date fruit pomace to enable more efficient fibrillation during processing 140.

Contacting 130 may be done after or concurrent to heating 120 water. Contacting may be done at any point before processing 140. In some embodiments, contacting 130 involves fully submerging date fruit pomace into water so the entirety of the date fruit pomace is below the surface of the water. In some embodiments, contacting 130 involves partially immersing date fruit pomace into water so less than the entirety of the date fruit pomace is below the surface of the water at any given time. In some embodiments, contacting 130 involves surface wetting, wherein water is sprayed, dripped, or otherwise applied to date fruit pomace. In some embodiments, contacting 130 involves washing date fruit pomace with water. In some embodiments, contacting 130 may be intermittent or cycled immersion, allowing for portions of date fruit pomace to be immersed at various times in the contacting 130 process. In some embodiments, contacting 130 lasts for less than 1 hour. In some embodiments, contacting 130 lasts for at least, equal to, or between any two of 1, 2, 3, 4, and 5 hours. In some embodiments, the water temperature is maintained at a constant temperature over the duration of contacting 130. In some embodiments, the water temperature is varied between one or more temperatures between 7° and 100° C. over the duration of contacting 130. In some embodiments, the water temperature is lowered below 70° C. at some point during contacting 130.

In some embodiments, method 100 for preparing cellulose nanofibrils includes removing hot water-treated date fruit pomace from the hot water. Removing may be done to extract dissolved impurities from hot water-treated date fruit pomace. In some embodiments, removing involves filtering hot water-treated date fruit pomace through a sieve. In some embodiments, the sieve has an average pore size of at least, equal to, or between any two of 200, 250, 300, 350, 400, 450, 500, 550, or 600 μm. In some embodiments, the sieve is a muslin cloth. In some embodiments, removing involves squeezing liquid out of hot water-treated date fruit pomace.

In some embodiments, method 100 for preparing cellulose nanofibrils includes treating hot water-treated date fruit pomace with one or more chemicals. In some embodiments, treating with chemicals takes place after contacting 130 with water. In some embodiments, treating with chemicals takes place before contacting 130 with water. In some embodiments, treating with chemicals can be performed at any time prior to processing 140. The primary effect of chemical treatments is the solubilization of lignin, hemicellulose, or other non-cellulose chemicals present in date fruit pomace. Various suitable chemical treatments are discussed herein, and embodiments may incorporate any combination of them to serve their respective purposes. Chemical treatments may involve similar procedures to contacting 130, but with respective non-water chemicals substituted for water.

In some embodiments, the chemicals used for chemical treatment include one or more alkalis. Alkalis are a type of base that dissolves in water to release hydroxide ions. Alkalis can solubilize lignin by cleaving ether and ester bonds between lignin and carbohydrates, fragmenting the lignin structure. Resulting lignin fragments readily dissolve into alkali solutions, allowing complete or partial lignin extraction from date fruit pomace. Alkalis also solubilize hemicellulose via deacetylation and partial hydrolysis of glycosidic linkages. These interactions may be enhanced by heating the solution. In some embodiments, alkalis include but are not limited to one or more of sodium hydroxide, calcium hydroxide, ammonium hydroxide, potassium hydroxide, and sodium carbonate. In some embodiments, the one or more alkalis used have concentrations of at least, equal to, or between any two of 0.5, 0.6, 0.7, 0.8, 0.9, and 1.0 M.

In some embodiments, the one or more bases used for chemical treatment include one or more oxidizing agents. In some embodiments, the one or more oxidizing agents includes one or more oxidizing bleaches. Oxidizing bleaches are chemical agents that alter or break down chromophores in organic substances via oxidation. Oxidizing agents and oxidizing bleaches target chromophores present in lignin to degrade, polarize fragments, and solubilize lignin present in date fruit pomace. In some embodiments, oxidizing agents include but are not limited to one or more of sodium hypochlorite, hydrogen peroxide, chlorine dioxide, and ozone. In some embodiments, oxidizing agents are selective for structures found particularly in lignin. In some embodiments, the one or more oxidizing agents have concentrations of at least, equal to, or between any two of 0.7, 0.8, 0.9, 1.0, 1.1, 1.2, 1.3, 1.4, 1.5, 1.6, 1.7, 1.8, 1.9, and 2.0 wt %.

In some embodiments, method 100 for preparing cellulose nanofibrils includes rinsing hot water-treated date fruit pomace with water. Rinsing is a treatment technique that may extract loose impurities that were not extracted during removing. In embodiments involving one or more chemical treatments using chemicals other than water, rinsing may be done after one or more of the chemical treatment steps remove residual chemicals used during the respective treatment steps. Rinsing after chemical treatments may also neutralize hot water-treated date fruit pomace if its pH had been adjusted by chemical treatments. The water used in rinsing need not be a particular temperature but may take liquid form. In some embodiments, the water used in rinsing has a temperature of at least, equal to, or between any two of 5, 10, 15, 20, 25, 30, 40, 50, 60, 70, 80, 90, or 100° C. In some embodiments, method 100 includes steaming hot water-treated date fruit pomace with gaseous water following removing. This process accomplishes similar objectives as rinsing regarding extracting loose impurities that were not extracted during removing or chemical treatments.

In some embodiments, method 100 includes drying hot water-treated date fruit pomace. Drying involves removing remove some, substantially all, or all water from hot-water treated date fruit pomace. Drying may include one or more of air drying, heat drying, blotting, and desiccating.

Processing 140 includes mechanically processing hot water-treated date fruit pomace to produce CNFs via fibrillation. Fibrillation is the process by which cellulosic materials are broken down into much smaller structures such as nanofibrils (fibrils having diameters of less than 100 nm). Fibrillation may be more effective with fewer non-cellulose compounds in the hot water-treated date fruit pomace. In some embodiments, hot-water treated date fruit pomace may be added to water prior to processing 140 to create a hydrocolloid or a slurry. In some embodiments, hot-water treated date fruit pomace may already be disposed in water prior to processing 140 following contacting 130 and/or rinsing. In some embodiments, processing 140 involves one or more of shear mixing, blending, mixing, homogenizing, beating, and manually agitating hot water-treated date fruit pomace.

Due to date fruit pomace having weakly connected cellulose fibers, these fibers are naturally weakly fibrillated, meaning they can easily break down into smaller fibrils or nanofibers when mechanically pressed. As a result, shear mixing may be used to efficiently fibrillate date fruit pomace. Blending, shear mixing, homogenizing, beating, and even manual agitation all use shear pressures to break down the pomace's fibrous structure. In embodiments where processing is completed with hot-water treated date fruit pomace in water, mechanical action disperses the fibers, resulting in a stable and uniform hydrocolloid dispersion containing nanofibers. The method increases the water retention, viscosity, and stability of the resultant mixture, making it appropriate for a variety of applications. These processing techniques utilize the weak internal bonding of date fruit pomace fibers to make tiny, stable fiber dispersions with little energy input. In some embodiments, processing 140 involves techniques and equipment that use significantly less energy than the typical techniques of homogenization, micro-fluidization, grinding, cryo-crushing, or high-intensity ultrasonication.

In some embodiments, processing 140 lasts for at least, equal to, or between any two of 10, 20, 30, 40, 50, 60, 120, or 180 minutes. In some embodiments, processing 140 lasts until a target average CNF diameter is reached. In some embodiments, the target average CNF diameter may be at most, equal to, or between any two of 30, 40, 50, 60, 70, 80, 90, and 100 nm.

CNFs produced according to method 100 may have beneficial properties and morphologies for use as nanomaterials. In some embodiments, CNFs consist of intertwined bundles of flexible, elongated nanofibrils. In some embodiments, CNFs produced according to method 100 have average diameters of at most, equal to, or between any two of 10, 15, 20, 25, 30, 40, 50, 60, 70, 80, 90, and 100 nm. In some embodiments, CNFs produced according to method 100 have more than 95% of all CNFs with diameters of at most, equal to, or between any two of 30, 40, 50, 60, 70, 80, 90, 100, 150, 200, and 250 nm. In some embodiments, CNFs produced according to method 100 have CNF lengths between 8, 8.5, 9, 9.5, 10, 10.5, and 11 μm.

In some embodiments, hydrocolloids made with CNFs produced according to method 100 have beneficial rheological properties. In some embodiments, CNF-containing hydrocolloids have pronounced solid gel-like behavior, exhibiting higher storage moduli (G′) than loss moduli (G″) during rheological analysis. In some embodiments, CNF-containing hydrocolloids exhibit typical non-Newtonian shear-thinning behavior. In some embodiments, the strong, elastic network structure of CNFs forms a robust, percolating network through hydrogen bonding and entanglement, making CNFs suitable for reinforcement of other materials such as hydrogels, composites, and films by increasing the mechanical strength, stability, and endurance of other materials.

In some embodiments, CNFs produced according to method 100 have excellent cytocompatibility. In some embodiments, CNFs have no negative effects on proliferative or metabolic activity of human skin cells upon exposure. In some embodiments, CNFs produced according to method 100 are cytocompatible with human cells.

In some embodiments, CNFs produced according to method 100 have beneficial shelf stability. In some embodiments, CNFs are able to maintain hydrocolloidal shelf dispersions for at least, equal to, or between any two of 12, 24, 36, and 48 hours.

### EXAMPLES

Example 1. Hot water treatment. Date pomace was obtained as a byproduct from date syrup processing. Water was added to a 250 mL sterile conical flask and heated to 80° C. Pomace was placed in the water. The solution was stirred at a constant temperature of approximately 80° C. for 1 hour. The pomace was then filtered through a, muslin cloth (˜40-60 mesh having average pore diameter of approximately 250-500 μm), and air dried to produce water-treated date fruit pomace (“WTP”).

Example 2. Alkali treatment. An alkali solution including 1M sodium hydroxide was added to a 250 mL sterile conical flask and heated to 70° C. Water treated date fruit pomace was placed in the alkali solution. The solution was stirred at a constant temperature of approximately 70° C. for 2 hours. The pomace was then filtered through a (˜40-60 mesh having average pore diameter of approximately 250-500 μm) muslin cloth, washed with water to achieve pH of 7, and air dried to produce alkali treated date fruit pomace (“ATP”).

Example 3. Oxidizing bleach treatment. An oxidizing bleach solution including a sodium hypochlorite solution diluted to 1.7 wt % was added to a 250 mL sterile conical flask and heated to 70° C. Alkali treated date fruit pomace was placed in the oxidizing bleach solution. The solution was stirred at a constant temperature of approximately 70° C. for 2 hours. The pomace was then filtered through a 100 μm mesh sieve, washed with water to achieve pH of 7, and air dried to produce oxidizing bleach treated date fruit pomace (“BTP”).

Example 4. Processing. The following process was conducted using WTP, ATP, and BTP (generically referred to herein as “pomace”). Pomace was suspended in water to create four aqueous dispersions with approximately 2, 1, 0.5, 0.1, and 0.01 wt % pomace. The aqueous dispersions were mixed using a shear mixer at 6000 RPM for 30 minutes at room temperature to create pomace cellulose nanofibril (CNF) hydrocolloids. CNF hydrocolloids made using WTP, ATP, and BTP are referred to herein as WTP-CNFs, ATP-CNFs, and BTP-CNFs, respectively.

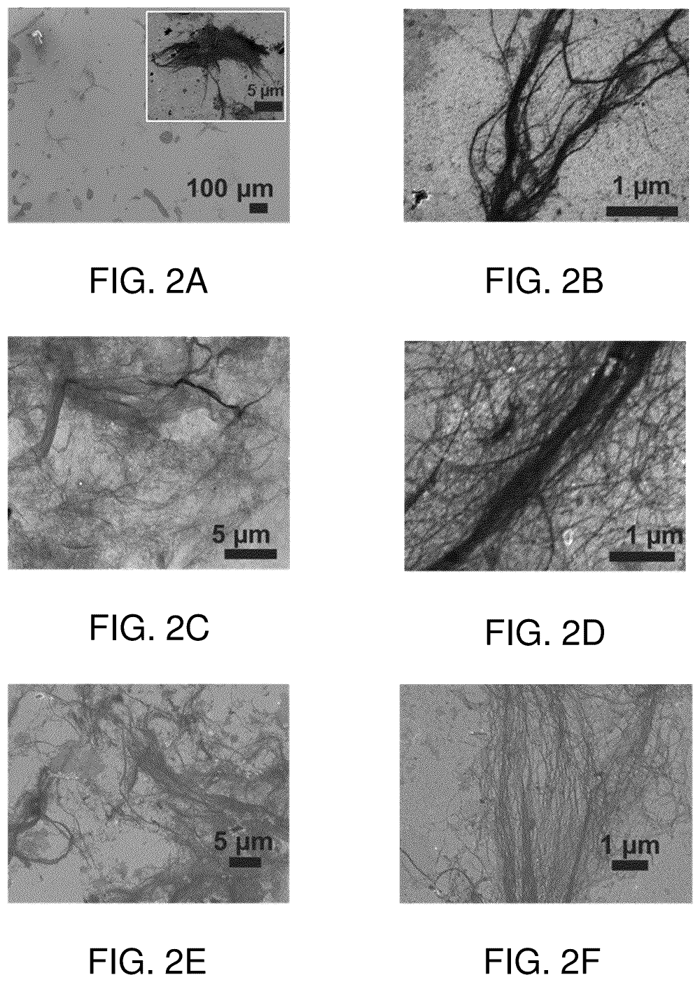

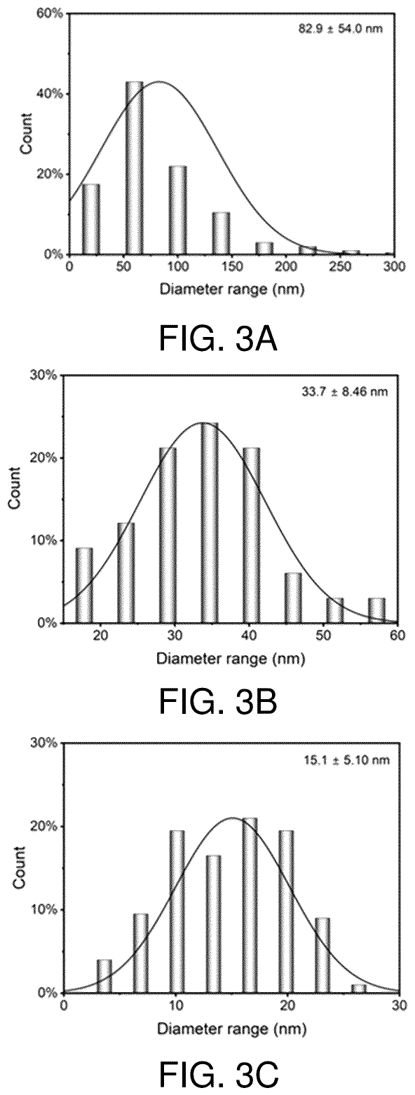

Example 5. Morphological analysis. CNF hydrocolloids WTP-CNF, ATP-CNF, and BTP-CNF were analyzed using Field Emission Scanning Electron Microscopy (FE-SEM) to determine morphological characteristics. FIGS. 2A-B illustrate FE-SEM images of WTP-CNF at various zoom levels. FIGS. 2C-D illustrate FE-SEM images of ATP-CNF at various zoom levels. FIGS. 2E-F illustrate FE-SEM images of BTP-CNF at various zoom levels. FIGS. 3A-C illustrate graphs illustrating the distribution of nanofibril diameters as measured by analysis of FE-SEM images of WTP-CNF, ATP-CNF, and BTP-CNF, respectively, with the average CNF diameter included in the top right corner. Overall morphological analysis of CNF hydrocolloids showed that all three samples included CNFs with lengths between 8.7 and 10.5 μm and diameters between 15 and 80 nm. Morphological analysis of WTP-CNF showed lower fibrillation than the other samples, characterized by having a higher average fibril diameter of 82.9 nm, denser groups of nanofibrils, and lower amounts of fibrillated strands. These dimensions are significantly smaller compared to CNFs derived from wood fibers. This invention demonstrates a viable approach for transforming date pomace waste into CNFs using a low-energy and environmentally friendly method, opening doors for various potential applications.

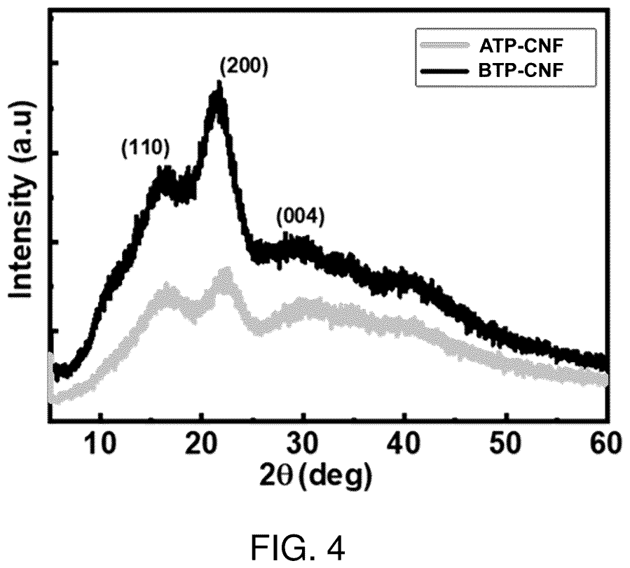

Example 6. X-ray diffraction analysis. CNF hydrocolloids ATP-CNF and BTP-CNF were analyzed using x-ray diffraction analysis to characterize crystal structure and chemical composition. FIG. 4 illustrates x-ray diffraction patterns of ATP-CNF and BTP-CNF. Patterns of both samples feature peaks at 16.87°, 22.54°, and 34.37° which are characteristic of cellulose I, indicating its presence in both CNFs. Notably, the peak strength of BTP-CNF is substantially greater than that of ATP-CNF, indicating a greater concentration of cellulose I in BTP-CNF compared to ATP-CNF which may be caused by a decrease in lignin and/or hemicellulose in BTP-CNF. These results may be explained by the delignifying and/or hemicellulose solubilizing effects that oxidizing bleach has on CNFs.

Example 7. Rheological analysis. Samples containing 0.5, 1.0, and 2.0 wt % of BTP-CNF were subjected to rheological characterization using a stress-controlled rheometer (MCR 301, Anton Paar, Austria) fitted with a cone-and-plate geometry (60 mm diameter, 2° cone angle, and a 0.208 mm gap). Prior to measurements, the CNF suspensions were rested on the rheometer plate for 1 minute to eliminate the influence of loading-induced shear history. All rheological tests were conducted at a controlled temperature of 25° C. The viscoelastic behavior of the CNF hydrocolloids was examined through oscillatory shear tests. Initially, strain sweep experiments ranging from 0.1% to 10% strain were performed at a fixed angular frequency of 1 Hz to establish the linear viscoelastic region. Subsequently, frequency sweep measurements were carried out within the range of 0.01 to 100 Hz at a constant strain amplitude of 1%.

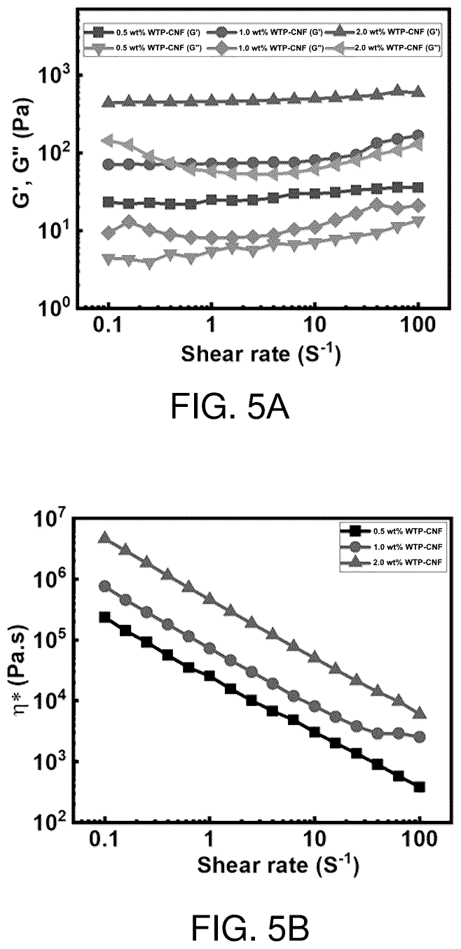

FIG. 5A illustrates a graph showing the results of frequency sweep measurements as expressed in a log-log plot of storage modulus (G′) and loss modulus (G″) with the function of angular frequency of hydrocolloids containing 0.5, 1.0, and 2.0 wt % BTP-CNF. Analysis of this graph shows that all hydrocolloid suspensions exhibit pronounced solid gel-like behavior, as indicated by the storage modulus (G′) consistently exceeding the loss modulus (G″) throughout the measured angular frequency range. Both G′ and G″ increased gradually with an increase in CNF-containing hydrocolloid concentrations, suggesting enhanced network formation in the hydrocolloidal system. At 10 s⁻¹, G′ increases from ˜30 to 500 Pa and G″ from ˜7 to 59 Pa as CNF concentration rises from 0.5 to 2 wt %, ensuring the concentration-dependent strengthening of the viscoelastic network. This behavior is attributed to the high aspect ratio and entangled nanofiber architecture of the date fruit pomace-derived CNF, which imparts structural rigidity and limits molecular mobility within the suspension, thereby promoting a more solid-like response.

FIG. 5B illustrates a graph showing complex viscosity (η*) of hydrocolloids containing 0.5, 1.0, and 2.0 wt % WTP-CNF, expressed as a function of angular frequency. All hydrocolloids demonstrated typical non-Newtonian shear-thinning behavior, where viscosity decreased with increasing shear rate. Additionally, η* values increased with higher nanofiber concentrations across all frequency ranges, indicating a concentration-dependent enhancement in network density. The viscosity increases consistently with DP-CNF concentration: at a shear rate of 0.1 s⁻¹, η* increases by roughly fourfold from 0.5 wt % (˜2×10⁵ Pa·s) to 1 wt % (˜8×10⁵ Pa·s), and then about sixfold more at 2 wt % (˜5×10⁶ Pa·s). This behavior is consistent with the formation of a robust, interconnected fibrous matrix, governed by the intrinsic morphology and interaction potential of the cellulose nanofibers. Moreover, this phenomenon is almost similar to the chemically oxidized nanocellulose fiber hydrocolloidal system, supporting that a less energy-intensive process is highly suitable and benchmark to obtain the highly stable hydrocolloidal date pomace-based nanocellulose system.

Example 8. Metabolic activity analysis. The cytocompatibility of BTP-CNF hydrocolloids was assessed using the following procedure. BTP-CNF samples were sterilized overnight using UV treatment. The sterilized samples were then dispersed in phosphate buffer saline to make a 1 wt/v % suspension, and 100 μL of the suspension was added per well for cell culture. Human Dermal Fibroblasts-Adult (HDF-Ad) were seeded at a density of 25,000 cells per well in 48-well plates and allowed to attach for 24 hours. After this period, 100 μL of the liquid nanocellulose was added to each well. To evaluate the proliferation and metabolic activity of HDF-Ad cells cultured with nanocellulose, the Alamar Blue assay (Thermo Fisher Scientific, USA) was performed on days 1, 3, and 7. For each time point, cells were incubated for 4 hours with 1 mL of 10% Alamar Blue solution prepared in complete DMEM. Absorbance was measured at 570 nm and 600 nm using a multimode microplate reader (Infinite M200 Pro, Tecan), and the percentage of dye reduction was calculated to determine cell viability.

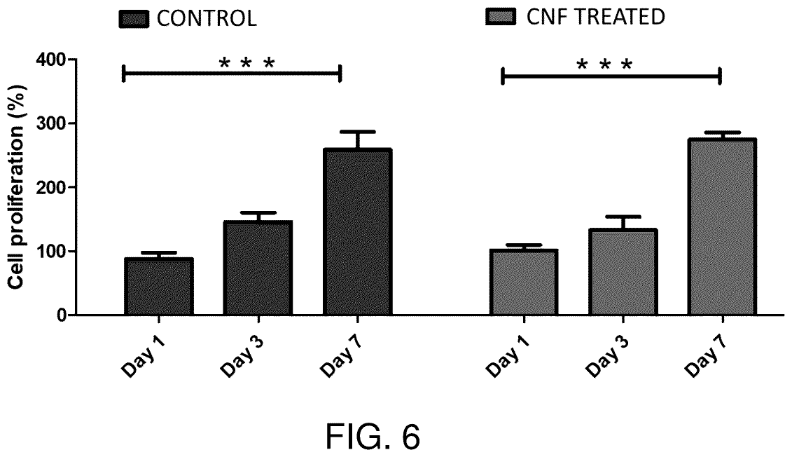

FIG. 6 illustrates results of Alamar Blue assays conducted on BTP-CNF treated cells and untreated cells (used as a control). The results of these assays show a two-fold increase in cell metabolic activity by day 7, indicating enhanced cell proliferation over time. The metabolic activity of fibroblast cells was not inhibited by the nanocellulose solution. Both the treated and control groups showed comparable levels of proliferation, suggesting that the nanocellulose solution is biocompatible and does not negatively affect cell viability or growth.

Example 9. CNF hydrocolloid shelf stability. ATP-CNFs and BTP-CNFs were visually inspected immediately after preparation (0 hours) and 48 hours later to determine shelf stability. Visual inspection of the samples revealed no significant visual change to the CNF hydrocolloids, indicating that CNF hydrocolloids are highly stable and capable of maintaining hydrocolloidal dispersions for at least 48 hours.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for preparing cellulose nanofibrils comprising:
providing date fruit pomace,
heating water to at least 70° C.,
contacting the date fruit pomace with water either before or after heating to produce hot water-treated date fruit pomace, and
processing the hot water-treated date fruit pomace to produce cellulose nanofibrils.

2. The method of claim 1, further comprising removing hot water-treated date fruit pomace from the water before processing.

3. The method of claim 1, further comprising contacting date fruit pomace with one or more alkalis either before or after contacting with water.

4. The method of claim 3, wherein the one or more alkalis include one or more of sodium hydroxide, calcium hydroxide, ammonium hydroxide, potassium hydroxide, and sodium carbonate.

5. The method of claim 1, further comprising contacting date fruit pomace with one or more oxidizing agents either before or after contacting with water.

6. The method of claim 5, wherein the one or more oxidizing agents include bleach.

7. The method of claim 5, wherein the one or more oxidizing agents include sodium hypochlorite, hydrogen peroxide, chlorine dioxide, and ozone.

8. The method of claim 1, wherein processing involves one or more of blending, stirring mixing, shear mixing, homogenizing, beating, and manually agitating.

9. The method of claim 1, wherein contacting with water involves fully submerging, partially immersing, and surface wetting date fruit pomace with water.

10. The method of claim 1, wherein contacting is intermittent.

11. The method of claim 1, wherein hot water-treated date fruit pomace is processed until cellulose nanofibrils have average diameters of less than 100 nm.

12. The method of claim 1, wherein the cellulose nanofibrils produced are cytocompatible with human cells.

13. The method of claim 1, further comprising dispersing cellulose nanofibrils in water to produce cellulose nanofibril hydrocolloids.

14. The method of claim 13, wherein the cellulose nanofibril hydrocolloids exhibit solid gel-like rheological properties.

15. The method of claim 13, wherein the cellulose nanofibril hydrocolloids exhibit non-Newtonian shear-thinning behavior.

16. The method of claim 13, wherein cellulose nanofibril hydrocolloids are shelf stable for at least 48 hours.

17. A method for preparing cellulose nanofibrils comprising:
providing date fruit pomace,
heating water to at least 70° C.,
contacting the date fruit pomace with water either before or after heating,
contacting the date fruit pomace with one or more alkalis,
contacting the date fruit pomace with one or more oxidizing agents, and
processing the date fruit pomace to produce cellulose nanofibrils
wherein contacting the date fruit pomace with water can be performed at any time prior to processing, contacting with one or more alkalis can be performed at any time prior to processing and contacting with one or more oxidizing agents can be performed at any time prior to processing.

18. The method of claim 17, wherein the one or more alkalis include one or more of sodium hydroxide, calcium hydroxide, ammonium hydroxide, potassium hydroxide, and sodium carbonate.

19. The method of claim 17, wherein the one or more oxidizing agents include sodium hypochlorite, hydrogen peroxide, chlorine dioxide, and ozone.

20. A method for preparing cellulose nanofibrils comprising:
providing date fruit pomace,
heating water to between 70-100° C.,
contacting the date fruit pomace with water either before or after heating to produce hot water-treated date fruit pomace, and
processing the hot water-treated date fruit pomace to produce cellulose nanofibrils.
